(19) United States
(12) Patent Application Publication
(10) Pub. No.: US 2023/0193018 A1
(43) Pub. Date: Jun. 22, 2023

(54) TOY BUILDING BRICKS MADE OF RECYCLED ABS MATERIAL

(71) Applicant: LEGO A/S, Billund (DK)

(72) Inventors: Søren KRISTIANSEN, Billund (DK); Søren MØLLER-SØRENSEN, Billund (DK); René MIKKELSEN, Billund (DK); Bistra ANDERSEN, Billund (DK); Emil ANDERSEN, Billund (DK); Carina Gejl NIELSEN, Billund (DK); Anders Christian JENSEN, Billund (DK)

(21) Appl. No.: 17/966,299

(22) Filed: Oct. 14, 2022

Related U.S. Application Data
(63) Continuation-in-part of application No. 16/767,215, filed on May 27, 2020.
Application No. 16/767,215 is a continuation-in-part of application No. 16/767,201, filed on May 27, 2020.
Application No. 16/767,201 is a continuation-in-part of application No. 16/767,229, filed on May 27, 2020.

(30) Foreign Application Priority Data
Dec. 1, 2017 (DK) PA201770900
Dec. 1, 2017 (DK) PA201770901
Dec. 1, 2017 (DK) PA201770902
Apr. 15, 2020 (EP) 20169555.8

(51) Int. Cl. C08L 55/02; C08J 11/08; C08J 11/12

(52) U.S. Cl. CPC C08L 55/02; C08J 11/08; C08J 11/12; C08J 2355/02; C08L 2207/20; C08L 2205/025; C08L 2205/18; C08L 2203/30; A63H 33/086

(57) ABSTRACT

A toy building element made of recycled Acrylonitrile Butadiene Styrene (“ABS”) material and manufactured by processing, of a resin comprising, mechanically recycled ABS polymers and/or chemically recycled ABS polymers recovered from a solvent dissolution recycling process. A method for the manufacture of a toy building element includes providing and screening an ABS waste material. The method includes recovering recycled ABS polymers from the screened ABS waste material by subjecting the ABS waste material to grinding and/or a solvent dissolution recycling process. The method includes obtaining a resin by mixing the recovered ABS polymers with one or more additive(s) and optionally one or more ABS polymers selected from the group consisting of virgin ABS polymers, chemically recycled ABS polymers recovered from pyrolysis and chemically recycled ABS polymers recovered from chemical depolymerisation. The method thereafter includes manufacturing the toy building element by processing the resin.

### CROSS-REFERENCE TO RELATED APPLICATIONS

The present application is a U.S. National Stage Application of International Application No. PCT/EP2021/059742, tiled on Apr. 15, 2021 and published on Oct. 21, 2021 as WO 2021/0209533 A1, which claims the benefit and priority of European Patent Application No. 20169555.8, filed on Apr. 15, 2020, each of which is incorporated herein by reference in its entirety for any purpose whatsoever.

The present application is also a Continuation-in-Part of U.S. patent application Ser. No. 16/767,201, filed May 27, 2020 and published on Dec. 17, 2020 as U.S. Patent Publication. No. 2020/0391133 A1, which is a U.S. National Stage Application of International Application No. PCT/EP2018/083082, filed on Nov. 30, 2018 and published on Jun. 6, 2019 as WO 2019/106124, which claims the benefit and priority to Danish Patent Application No. PA 201770900, filed on Dec. 1, 2017, each of which is incorporated herein by reference in its entirety for any purpose whatsoever.

The present application is also a Continuation-in-Part of U.S. patent application Ser. No. 16/767,215, filed May 27, 2020 and published on Jan. 7, 2021 as U.S. Patent Publication No. 2021/0001240 Al, which is a U.S. National Stage Application of International Application No. PCTIEP2018/083090, filed on Nov. 30, 2018 and published on Jun. 6, 2019 as WO 2019/106129, which claims the benefit and priority to Danish Patent Application No. PA 201770901. filed on Dec. 1, 2017, each of which is incorporated herein by reference in its entirety for any purpose whatsoever.

The present application is also a Continuation-in-Part of U.S. patent application Ser. No. 16/767,229, filed May 27, 2020 and published on Nov. 26, 2020 as U.S. Patent Publication No. 2020/0368633 Al, which is a U.S. National. Stage Application of International Application No. PCT/EP2018/083095, filed on Nov. 30, 2018 and published on Jun. 6, 2019 as WO 2019/106133, which claims the benefit and priority to Danish Patent Application No. PA 201770902, tiled on Dec. 1, 2017, each of which is incorporated herein by reference in its entirety for any purpose whatsoever.

### FIELD OF DISCLOSURE

The present disclosure relates to toy building elements made of a recycled Acrylonitrile Butadiene Styrene (ABS) material arid manufactured by processing of a. resin comprising a recycled ABS polymer.

### BACKGROUND

Toy building elements have been manufactured and marketed for many years. Traditionally, such toy building elements are made of petroleum-based polymers, such as ABS.

ABS is an engineering thermoplastic polymer, which is manufactured by polymerizing styrene and acrylonitrile in the presence of polybutadiene. The proportions can vary from 15 to 35% acrylonitrile, 5 to 30% butadiene and 40 to 60% styrene. ABS consists of an amorphous-continuous phase and a rubbery-dispersed phase. Poly(styrene-co-acrylonitrile) (SAN) copolymer forms the continuous phase and the second phase consists of dispersed butadiene, or butadiene copolymer. The butadiene particles have a layer of SAN grafted onto their surface, which makes the two phases compatible. The properties of ABS are given by the composition, thermoplastic and rubbery phase characteristics and interaction between them. Thus, the content and molecular weight of SAN controls properties such as processability, heat resistance, surface hardness. and chemical resistance. The butadiene content contributes mainly to toughness,

ABS can be manufactured by emulsion polymerization and mass polymerization. ABS materials with different properties are obtained depending on whether the ABS has been produced by emulsion or mass polymerization. For example, a high glossy surface of the ABS material may he obtained when producing ABS by emulsion polymerization, whereas a low surface gloss is usually obtained when the ABS material is produced by mass polymerization.

The increasing concern about diminishing petroleum resources and the impacts of the global warming has encouraged development of techniques for recycling of ABS and for producing the ABS polymer by using biomass as the renewable resource.

ABS can be produced by using biomass as the renewable resource. WO 2015/034948 A1 describes a process of producing biobased organic chemicals such as bio-acrylic acid, bio-acrylonitrile and bio-1,4butadiene using renewable carbon sources as feedstock. In a first stage, bio-1,3-propanediol is derived from renewable carbon sources through microbial fermentation and in a second stage, bio-1,3-propanediol is converted into bio-acrylic acid or bio-acrylonitrile or bio-1,4-butadiol.

ABS can also be produced by using material, which has been obtained using a carbon capture technique, i.e. the material has been produced using carbon monoxide and/or carbon dioxide, which has been captured directly from the air or from gasses from industrial processes, Such carbon capture techniques include for example absorption, adsorption., chemical looping, and membrane separation. technology. The captured carbon oxide may then be converted into hydrocarbons, such as for example methanol or ethanol, which can be used as source for making new monomers or polymers.

ABS can also be obtained by mechanical or ch recycling of ABS material.

Mechanical recycling of ABS involves only mechanical processes, such as for example grinding, washing, separating, drying, re-granulating and compounding. In a typical recycling process, the waste ABS plastic is collected and washed in order to remove contaminants. The cleaned plastic is then grinded into flakes, which can be compounded and pelletized or reprocessed into granulate.

One problem relating to the use of mechanically recycled ABS material is that the properties of the recycled ABS material are usually worse than the virgin ABS material. This is due to degradation phenomena that occur during the lifetime of ABS and during melt reprocessing operations that accelerate the degradation effect. During reprocessing, the ABS material is subjected to high temperatures and shear stresses, which cause different types of degradation reactions. The degree of degradation depends on the number of cycles and processing temperature. It is also expected that for post-consumer recycled ABS, the exposure from light, elevated temperature, and chemicals during use will cause further degradation, it is believed that ABS degrades due to chain scission and crosslinking, creating oligomeric products that can migrate to the surface and brittle crosslinked polybutadiene particles. The chemical changes have a markedly negative effect on e.g, impact strength and it is necessary to improve the performance of the recycled polymers by adding suitable additives or by blending it with virgin polymer.

Another problem relating to the use of mechanically recycled ABS material is the presence of hazardous and/or non-acceptable additives and other unwanted substances in the waste ABS used for recycling. The ABS waste material is typically washed before recycling, but this washing step does not remove all of the additives and other unwanted substances, which are present within the waste material. Some kinds of additives may be hazardous and their presence is therefore not acceptable in the recycled ABS material when used to manufacture toys such as recycled toy building elements. In particular, substances that are classified as carcinogenic, mutagenic or toxic for reproduction (CMR) of category 1A, 1B or 2 under Regulation (EC) No 1272/2008 are unwanted substances in. the recycled material. Also the presence of toxic metals must be avoided. Flame retardants in waste from WEEE (waste electrical and electronic equipment) are a further example of a non-acceptable type of additive.

Other kinds of additives that may be present in the waste ABS include pigments, for example iron oxides, which contribute to continuous degradation of the ABS material during the item's lifetime before the ABS item is thrown out as waste. Other kinds of additives may be impact modifiers, which affect the impact strength of the recycled ABS material, lubricants, which may influence material processing as well as friction properties, and coloring agents, which may affect both the color and the mechanical properties of the recycled ABS material. The ABS waste material may also contain unwanted substances that have been absorbed during the use phase. Such substances may include organic solvents, cleaning agents and food components. The ABS waste tl material may also contain decorations, which include other monomers and solvents.

Yet another problem relating to the use of mechanically recycled ABS polymers is that recycled ABS is only commercially available in dark grey and black colors. Suitable coloring treatments must be developed in order to produce brightly colored toys made of recycled ABS material.

Chemical recycling of ABS refers to any process by which the ABS waste material is chemically converted into its original monomers and/or oligomers that can be used to produce new virgin-like polymers to create ABS items. This type of chemical recycling processes includes pyrolysis and chemical depolymerization. Chemical recycling also refers to any process where the ABS waste material may be dissolved using a suitable solvent, and the dissolved ABS polymers are then typically recovered by precipitation of the polymer or by evaporation of the solvent. This type of chemical recycling process is typically referred to as “solvent dissolution”.

Pyrolysis refers to breakdown of the ABS material at elevated temperature in the absence of oxygen. Pyrolysis turns plastic into a pyrolysis oil that can be further refilled. New virgin-like polymers can then be made from the resulting oil by known polymerization processes.

Chemical depolymerization is the process of breaking down of a polymer into monomers, oligomers, or mixtures of monomers and/or oligomers and/or intermediates thereof using a chemical. The process removes additives and colorants from the monomers/intermediates. New virgin-like polymers can be produced by polymerization of the monomers. Today, no commercial available technology exists, which is suitable for depolymerization of ABS waste material. New virgin ABS polymers can, however, be manufactured by polymerization of monomers, which has been recovered by depolymerization of other types of plastic waste. For example, the styrene monomer may be recovered by depolymerization of polystyrene as described in WO 2016/049782.

Solvent dissolution involves selective extraction of polymers using solvents. Any additives and colorants are removed and the resulting polymers are recovered typically by precipitation of the polymers or by evaporation of the solvent. The polymer chain and structure is not broken down. Techniques have been developed also for dissolution-based recycling of ABS, where many solvents have been suggested for dissolution of ABS, such as for example acetone and tetrahydrofuran (THF).

One problem relating to the use of ABS polymers recovered from a solvent dissolution recycling process is that the solvent extraction also removes all additives. This means that the recycled. ABS material will not have the required properties, such as viscosity, mold release, friction, tillers and flame retardants, and it might need new protection additives, such is heat stabilizers, antioxidants, UV stabilizers and the like.

Another problem relating to the use of ABS polymers recovered from a solvent dissolution recycling process is that the solvent extraction will contain a. mixture of different. SAN chains and butadiene spheres. It is a challenge to compensate for the unforeseeable mixture of material components. Hence, it may be necessary to add short or long chain SAN to modify rheology or stiffness and it may be necessary to add butadiene spheres to improve impact properties. It may also be necessary to add different kinds of additives to compensate for lost additives during the solvent dissolution process.

The main problem relating to the use of recycled ABS, regardless of how it has been manufactured, is the. recovering of a less uniform polymer composition as compared to virgin polymer compositions. The degree of variation mainly depends on the waste material: the more uniform waste material the less degree of variation, It must be expected that recycled ABS possesses greater variations with regard to the ratio between styrene, butadiene and acrylonitrile, the chain length of the SAN co-polymers, the size and size distribution of the butadiene spheres, and the extend of SAN grafting on the surface of the butadiene spheres. Hence, greater effort is required to make. recycled ABS suitable and useful for the manufacture of items such as recycled toy building elements, in order to obtain items with satisfactory properties such as ,for example satisfactory impact strength, surface friction and color. In particular, if the manufacture of items with glossy surface is aimed at, it is important to know in advance that the ABS waste material has been produced by emulsion polymerization and that it also contains butadiene spheres of a suitable size, since the size of the butadiene spheres in the ABS material has proven to be important in order to obtain glossy surface of the finished item.

### SUMMARY

The present disclosure relates to toy building elements made of a recycled ABS (Acrylonitrile Butadiene Styrene) :material and manufactured by processing of a resin comprising recycled. ABS polymers. The inventors of the present disclosure have surprisingly found that toy building elements can be manufactured by processing of a resin comprising recycled ABS polymers.

A first aspect of the present disclosure relates to a toy building element, which is made of recycled ABS material.

A second aspect of the present disclosure relates to a method for the manufacture of a toy building element, which is made of recycled ABS material.

### BRIEF DESCRIPTION OF THE DRAWINGS

FIG. 1A shows a perspective view of an upper side of a traditional box-shaped 2*4 brick.

FIG. 1B shows a perspective view of a lower side of a traditional box-shaped 2*4 brick.

FIG. 2 shows the method fair the manufacture of a toy building element by processing of a resin comprising mechanically recycled ABS polymers and-or chemically recycled ABS polymers recovered from a dissolution recycling process.

FIG. 3 shows a method for the manufacture of a toy building element by processing of a resin comprising mechanically recycled ABS polymers.

FIG. 4 shows a method for the manufacture of a toy building element by processing of a resin comprising mechanically recycled ABS polymers, where the waste ABS material is discarded toy building elements.

FIG. 5 shows a method for the manufacture of a toy building element by processing of a resin comprising chemically recycled. ABS polymers recovered from a dissolution recycling process. In this embodiment both the SAN phase and the butadiene spheres are recycled.

FIG. 6 shows a method for the manufacture of a toy building element by processing of a resin comprising chemically recycled ABS polymers recovered from a dissolution recycling process. In this embodiment only the SAN phase is recycled and mixed with additives and virgin butadiene and optionally further ABS polymers.

FIG. 7 shows a method for the manufacture of a toy building element by processing of a resin comprising chemically recycled ABS polymers recovered from a dissolution recycling process. ill this embodiment only the SAN phase is recycled and mixed with additives and virgin ABS with high butadiene content.

### DETAILED DESCRIPTION

The present disclosure is directed to toy building elements made of recycled ABS material.

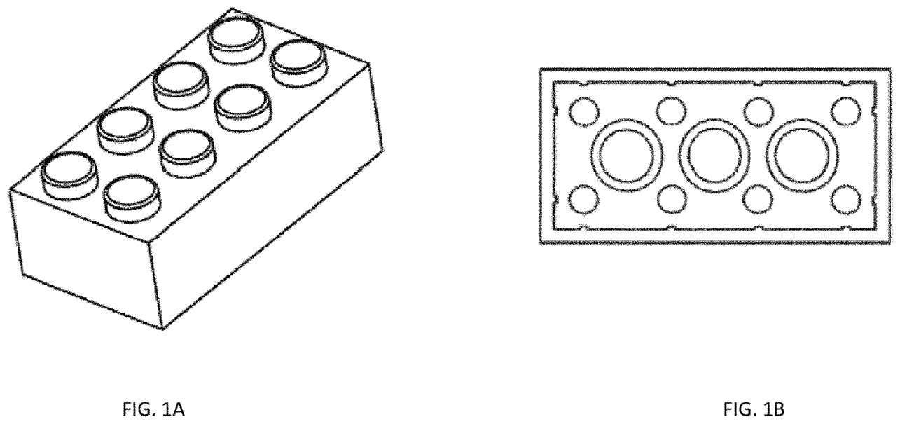

The term “toy building element” as used herein includes the traditional toy building elements in the form of box-shaped building bricks provided with knobs on the upper side and complementary tubes on the lower side. A traditional box-shaped toy building brick is shown to FIGS. 1A-1B. The traditional box-shaped toy building bricks were disclosed for the first time in U.S. Pat. No. 3,005,282 and are widely sold under the tradenames LEGO® and LEGO® DUPLO®. The term also includes other similar box-shaped building bricks, which are produced by other companies than The LEGO® Group and therefore sold under other trademarks than the trademark LEGO®.

The term “toy building clement” also includes other kinds of toy building elements that form part of a toy building set, which typically comprises a plurality of building elements that are compatible with and hence can be interconnected with each other. Such toy building sets are also sold under the trademark LEGO®, such as for example LEGO® bricks, LEGO® Technic and LEGO® DUPLO®. Some of these toy building sets includes toy building figures, such as for example LEGO® Minifigures (see for example U.S. Ser. No. 05/877,800), having complementary tubes on the lower side so that the figure can be connected to other toy building elements in the toy building set. Such toy building figures are also encompassed by the term “toy building element”. The term also includes similar toy building elements, which are produced by other companies than The LEGO® Group and therefore sold under other trademarks than the trademark LEGO®.

The toy building elements are available in a large variety of shapes, sizes, and colors. One difference between LEGO® bricks and LEGO® DUPLO® bricks is the size in that a LEGO® DUPLO® brick is twice the size of a LEGM: brick in all dimensions, The size of the traditional box-shaped LEGO® toy building brick haying 4⁴2 knobs on the upper side is about 3.2 CM in length, about 1.6 cm in width and about 0.96 cm in height (excluding knobs), and the diameter of each knob is about 0.48 cm. In contrast, the size of a LEGO® DUPLO® brick having 4*2 knobs on the upper side is about 6.4 cm in length, about 3.2 cm in width and about 1.92 cm in height (excluding knobs), and the diameter of each knob is about 0.96 em.

The toy building element is made of recycled ABS material and the element is manufactured by processing a resin comprising mechanically recycled ABS polymers and/or chemically recycled ABS polymers recovered from a solvent dissolution recycling process.

The term “recycled ABS material” as used herein refers to an. ABS material, which. is obtained by processing of a resin comprising recycled. ABS polymers. The recycled ABS polymers are obtained from ABS waste materials. The ABS waste material can be mechanically recycled ABS material or chemically recycled ABS material. The recycled ABS polymers in the resin are mechanically recycled ABS polymers and/or chemically recycled ABS polymers recovered from a solvent dissolution recycling process. In addition, the resin may further comprise virgin ABS polymers and/or chemically recycled ABS polymers recovered from a pyrolysis recycling process and/or recycled ABS polymers recovered from a chemical depolymerization recycling process.

“Mechanically recycled ABS material” refers to ABS material, which has been recovered by mechanically recycling of ABS material. Mechanical recycling involves only mechanical processes, such as for example grinding, washing, separating, drying, re-granulating and compounding. In a typical recycling process, the ABS waste material is collected and washed in order to remove contaminants. The cleaned plastic is then grinded into flakes, which can be compounded and pelletized or reprocessed into granulate.

“Chemically recycled ABS material” includes ABS materials made from ABS waste material which has been subjected to pyrolysis, chemical depolymerization, solvent dissolution or any other suitable chemical recycling process.

“Pyrolysis” refers to breakdown of the ABS material to pyrolysis oil at elevated temperature in the absence of oxygen. New virgin-like polymers can then be made from the resulting oil by known polymerization processes.

“Chemical depolymerization” refers to the process of breaking down of a polymer into either monomers, mixtures of monomers or intermediates thereof using a chemical agent. New virgin-like polymers can be produced by polymerization of the monomers,

“Solvent dissolution” refers to the selective extraction of polymers using solvents. The extracted polymers are recovered by precipitation of the polymer or by evaporation of the solvent. The polymer chain and structure is not broken down. Butadiene is present in ABS as distinct small spheres. The solvent dissolution will not change the chemical bonding in the polymer chains, but there is a risk for a physical change of the shape and size of the butadiene spheres. Therefore, it can be necessary to discard the butadiene spheres during the solvent dissolution process.

The term “recycled ABS polymer” refers to the ABS polymer comprised in the mechanically recycled ABS waste material or the polymer, which is chemically recovered from the ABS waste material in the solvent dissolution process. The term also refers to the virgin-like ABS polymer, which is produced in the pyrolysis recycling process or the chemical depolymerization recycling process. When the term refers to virgin-like ABS polymers then it also includes polymers where only one or two of the monomers have been recycled by pyrolysis or chemical depolymerization. For example, the term includes ABS polymers where part or all of the styrene monomers have been recycled by chemical depolymerization of polystyrene whereas the acrylonitrile and butadiene monomers could be non-recycled monomers produced by traditional manufacturing methods.

In some embodiments, the recycled ABS material comprises recycled ABS polymers. obtained from mechanically recycled ABS waste material. In other embodiments the recycled ABS material comprises recycled ABS polymers obtained from chemically recycled ABS waste material, where the ABS polymers have been recovered using a solvent dissolution recycling process. In yet other embodiments, the recycled ABS material comprises a mixture of recycled ABS polymers obtained from mechanically recycled ABS waste material and chemically recycled ABS waste material, where the ABS polymers have been recovered using a solvent dissolution recycling process. In further embodiments, the recycled ABS material may further comprise virgin ABS polymers and/or virgin-like ABS polymers, i.e. recycled ABS polymers recovered from a pyrolysis recycling process and/or from a chemical depolymerization recycling process.

The toy building elements are manufactured either by injection molding or by an additive manufacturing technique or by a combination of injection molding and an additive manufacturing technique. Alternatively, the toy building elements are manufactured by extrusion, optionally followed by molding using thermoforming or similar technology.

Injection molding of toy building elements is the traditional way of manufacturing toy bricks. This manufacturing technique has been used for many years and is very well known to a skilled person. In some embodiments, the toy building element is manufactured by injection molding of a resin comprising recycled ABS polymers. In other embodiments, the toy building element is manufactured by two-component injection molding, where one of the components is a resin comprising recycled ABS polymers. In yet other embodiments, the toy building element is manufactured by multi-component injection molding, where at least one of the components is a resin comprising recycled ABS polymers.

In recent years the new additively manufacturing technique for building objects in for example polymeric material has been developed, By the term “additive manufacturing” or “additively manufactured” as used herein is meant that the brick is. built in an additive fashion, i.e. by adding new material on top of either a substrate or on top of newly added material, by repeated solidification of a thin liquid layer or droplet on a substrate or on a previously solidified liquid layer or droplet, or by repeated printing with a thermoplastic polymeric material on a substrate or on a previously printed plastics material, or by repeated soldering in an additive fashion of plastics material, for example, by use of laser.

In some embodiments, the toy building element is manufactured by injection molding, hi other embodiments, the toy building element is manufactured by additive manufacturing. In yet other embodiments, the toy building element is manufactured by a combination of injection molding and additive manufacturing, Such combined manufacturing technique is described for example in WO 2014/005591 where a toy building element with high degree of design individuality is manufactured by adding material in the layer-by-layer fashion on the surface of a traditional injection molded box-shaped building brick.

In yet other embodiments, the toy budding element is manufactured by extrusion. Optionally, the extrusion process is followed by molding using thermoforming or similar technology.

It is known that the size of the butadiene spheres in the ABS material affects the degree of glossiness of the surface of the item manufactured by the ABS material. In the toy industry, a glossy surface is most often aimed at. Hence, in a preferred embodiment the size of the butadiene spheres in the recycled ABS material is less than or equal to 0.5 micrometers.

One of the major problems of manufacturing new toy building elements using recycled ABS material is the loss of mechanical properties, in particular impact strength. Sometimes this problem may be, at least partly, solved by adding virgin ABS polymers to the resin before processing the resin into the toy building clement. Alternatively, the problem may be solved by adding virgin-like ABS polymers or mixtures of virgin and virgin-like ABS polymers.

In one embodiment, the resin further comprises virgin ABS polymers. In some embodiments, the amount of virgin ABS polymer is at least 5 wt % of the total amount of polymer in the resin, such as for example at least 10 wt %, at least 30%, at least 50 wt %, at least 70 wt % or at least 90 wt %. In other embodiments, the amount of virgin ABS polymer is in the range of 5 to 95 wt % of the total amount of polymer in the resin, such as 10-95 wt %, 30-95 wt %, 50-95 wt %, 70-95 wt % or 80-95 wt %. In yet other embodiments, the amount of virgin ABS polymer is in the range of 5-50 wt % of the total amount of polymer in the resin, such as 5-30 wt %, 5-20 wt % or 5-10 wt %.

In other embodiments, the resin comprises virgin-like ABS polymers. By the term “virgin-like ABS polymers” as used herein is meant chemically recycled ABS polymers recovered from a pyrolysis recycling process and/or from a chemical depolymerization recycling process. In some embodiments the amount of virgin-like

ABS polymer is at least5 wt % of the total amount of polymer in the resin, such as for example. at least 10 wt %, at least :30 wt %, at least 50 wt %, at least 70 wt % or at least 90 wt %. In other embodiments. the amount of virgin-like ABS polymer is in the range of 5 to 95 wt % of the total amount of polymer in the resin, such as 10-95 wt %, 30-95 wt %, 50-95 vo%, 70-95 wt % or 80-95 wt %. In yet other embodiments, the amount of virgin-like ABS polymer is in the range of 5-50 wt % of the total amount of polymer in the resin, such as 5-30 wt %, 5-20 wt % or 5-10 wt %,

In yet other embodiments, the resin comprises a mixture of virgin and virgin-like ABS 1.0 polymers. In some embodiments, the combined amount of virgin and virgin-like ABS polymer is at least 5 wt % of the total amount of polymer in the resin, such as for example at least 10 wt %, at least 30 wt %, at least 50 wt %, at least 70 wt % or at least 90 wt %. In other embodiments, the combined amount of virgin and virgin-like ABS polymer is in the range of 5 to 95 wt % of the total amount of polymer in the resin, such as 10-95 wt %, 30-95 wt %, 50-95 wt %, 70-95 wt % or 80-95 wt %. In yet other embodiments, the combined amount of virgin and virgin-like ABS polymer is in the range of 5-50 wt % of the total amount of polymer in the resin, such as 5-30 wt %, 5-20 wt % or 5-10 wt %.

In preferred embodiments, the recycled ABS waste material is discarded toy building elements, and hence the recycled material is very similar to the virgin material except that the recycled material has been processed into toy building elements, which afterwards have been grinded into pellets or flakes. In such cases, it has surprisingly been found that toy building elements made entirely of mechanically recycled toy building elements having satisfactory mechanical properties, i.e. impact strength, can be manufactured even without incorporating new additives for improvement of the mechanical properties such as for example impact modifiers.

In some embodiments, the resin does not contain any virgin ABS polymer. In other embodiments, the amount of virgin ABS polymer is in the range of 0 to 95 wt % of the total amount of polymer in the resin, such as 0-50 wt %, 0-25 wt %, 0-10 wt % or 0-5 wt %.

The weight ratio between the mechanically recycled ABS polymers and the virgin ABS polymers may be in the range of 100:0 to 1:99, such as for example 100:0 to 10:90, 90:10 to 50:50 or 50:50 to 90:10.

In certain embodiments, the recycled ABS waste material is subjected to a solvent dissolution recycling process. In this process, the ABS polymers from the waste material are dissolved in a solvent and thereafter the dissolved ABS polymers are typically recovered by precipitation of the polymer or by evaporation of the solvent. In the dissolved state the polymers may he separated into two phases; one phase contains the polystyrene co-acrylonitrile) chains, also referred to as the SAN phase, and the other phase contains the butadiene copolymers, also referred to as the butadiene spheres.

In some embodiments, it may be suitable to recycle both the SAN phase and the butadiene spheres, whereas in other embodiments, it may be suitable only to recycle the SAN phase. In some eases where only the SAN phase is suitably recycled, the recycled SAN copolymers can be mixed with butadiene, which may be virgin butadiene or recycled butadiene or mixtures thereof In other cases, where only the SAN phase is suitably recycled, the recycled SAN copolymers can be mixed with ABS having, a high content of butadiene. The ABS having a high content of butadiene may be virgin ABS or recycled ABS or mixtures thereof.

By the term “ABS having a high content of butadiene” as used herein is meant an ABS having at least 20 wt % butadiene.

In yet other embodiments, the resin comprises mechanically recycled ABS polymers and chemically recycled ABS polymers recovered from a solvent dissolution recycling process. In some embodiments, the resin additionally comprises virgin ABS polymers.

Alternatively, the resin comprises mechanically recycled ABS polymers, recycled SAN copolymers and further ABS having a high content of butadiene. The ABS having a high content of butadiene may be virgin ABS or recycled ABS or mixtures thereof.

In other embodiments, the resin comprises mechanically recycled ABS polymers and the SAN phase recovered from ABS waste, which has been subjected to a solvent dissolution recycling process. In this embodiment, it may be suitable to further add either butadiene or ABS having a high content of butadiene or a mixture thereof. The butadiene and the ABS having a high content of butadiene may be of virgin or recycled origin or mixtures thereof.

In a real life injection molding system, the amount of recycled ABS is determined by the volume ratio of the mold and the mold runners system. When a new production starts up, the mold is fed with virgin material in the first run. The material, which is left in the runner systems and hence do not form part of the final injection molded element is grounded back into pellets or flakes or the like, and used as recycled material, which is mixed with virgin material and fed into the mold once more. This recirculation continues until a steady state situation has been reached, where the amount of recycled material will represent a certain constant percentage of the input material, and where the rest of the material will be virgin material. This constant percentage of recycled material will be referred to as recycled material after steady state.

The inventors of the present disclosure have surprisingly found that a markedly increase in Charpy v-notch is observed fur molded elements produced in molds running with a low percentage of recycled material after steady state. A particular example is described in Example 2 where a mold (mold 1) running with 42% recycled material after steady state produced molded bars with a relative Charpy v-notch value of 108%. Another mold (mold 2) running with 90% recycled material after steady state showed no decrease in relative Charpy v-notch value. These findings are very unexpected as a decrease in relative Charpy v-notch value would have been expected when ABS material is recycled.

Hence, in a particular preferred embodiment of the present disclosure the toy building element is produced by injection molding using a mold running with 20-95 wt %, such as for example 30-90 wt %, recycled material after steady state.

The resin, which is processed into the toy building element, may comprise a bin-based ABS polymer andior a hybrid bio-based ABS polymer.

By the term “bio-based ABS polymer” as used herein is meant an ABS polymer, is produced by chemical or biochemical polymerization of monomers derived from biomass. In some embodiments, the bin-based polymer is produced by chemical polymerization of monomers, which are all derived from biomass. In other embodiments, the bin-based polymer is produced by biochemical polymerization of monomers, which are all derived from biomass.

By the term “hybrid bin-based ABS polymer” as used herein is meant an ABS polymer, which is produced by polymerization, where at least one of the ABS monomers is derived from biomass and at least one of the ABS monomers is derived from petroleum, petroleum by-products or petroleum-derived feedstocks. The ABS monomers may be virgin monomers, chemical recycled monomers or mixtures of virgin and recycled monomers. The polymerization process is typically a chemical polymerization process.

In some embodiments at least part of the recycled ABS polymers are bio-based ABS polymers and/or hybrid bio-based ABS polymers. In other embodiments, at least part of the virgin. ABS polymers are bio-based ABS polymers and/or hybrid bio-based ABS polymers. In yet other embodiments, at least part of the recycled ABS polymers and at least part of the virgin ABS polymers are bio-based ABS polymers and/or hybrid bio-based ABS polymers.

In yet other embodiments, the toy building element may comprise ABS polymers, which have been produced using carbon capture techniques. By the term “ABS polymers, which have been produced using carbon capture techniques” as used herein is meant polymers, which contain carbon atoms from carbon monoxide and/or carbon dioxide, which has been captured directly from the air or from gasses from industrial processes.

In one embodiment, the total amount of ABS polymers in the resin is at least 50 wt % relative to the total weight of the resin. In other embodiments, the total amount of ABS polymers is at least 60 wt % or at least 70 wt % or at least 80 wt % relative to the total weight of the resin. In other embodiments, the total amount of ABS polymers is at least 85 wt %, such as at least 90 wt % relative to the total weight of the resin.

In another embodiment, the total amount of ABS polymers in the resin is 50-99 wt % relative to the total weight of the resin. In other embodiments, the total amount of ABS polymers is 60-95 wt % or 70-90 wt % or 80-85 wt % relative to the total weight of the resin. In other embodiments, the total amount of ABS polymers is 85-97 wt % or 90-97 wt % or 90-95 wt % or 90-92 relative to the total weight of the resin.

By the term “total amount of ABS polymers in the resin” as used herein is meant the total amount of ABS polymers in the resin regardless whether the ABS polymer is a recycled ABS polymer, a virgin ABS polymer, a bio-based ABS polymer, a hybrid bio-based ABS polymer and/or an ABS polymer, which has been produced using carbon capture techniques.

It may be beneficial to add additives to the resin comprising recycled ABS polymers in order to improve the properties of the toy building element manufactured by processing of the resin. In some embodiments, the resin comprising recycled ABS polymers comprises one or more additives, such as impact modifiers, fillers, antioxidants, lubricants, flame retardants, colorants, light stabilizers/UV absorbers and plasticizers.

The impact modifier may be a reactive impact modifier or it may be a non-reactive impact modifier. In some embodiments, the resin of recycled ABS polymers may comprise both reactive and non-reactive impact modifiers. In a preferred embodiment, the resin comprises a reactive impact modifier.

By the term “impact modifier” as used herein is meant an agent that, when added to the resin, increases the impact strength of the injection molded ABS element.

The reactive impact modifiers have functionalized end groups. Functionalization serves two purposes: 1) to bond the impact modifier to the polymer matrix and 2) to modify the interfacial energy between the polymer matrix and the impact modifier for enhanced dispersion. Preferred examples of such functionalized end groups include glycidylmethacrylates, maleic anhydrides and carboxylic acids.

In the present disclosure, reactive impact modifiers are preferred. In a preferred embodiment the impact modifier is a copolymer of the formula X/Y/Z where X is aliphatic or aromatic hydrocarbon polymer having 2-8 carbon atoms, Y is a moiety comprising an acrylate or methacrylate having 3-6 and 4-8 carbon atoms, respectively. and Z is a moiety comprising methacrylic acid, glycidyl methacrylate, maleic anhydride or carboxylic acid. In one preferred embodiment, the impact modifier may be described by the formula:

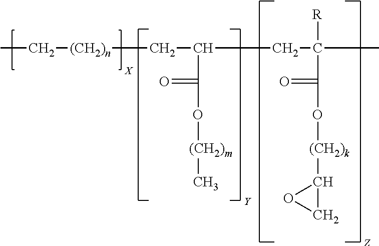

where

is an integer from 1 to 4,

m is an integer from 0 to 5,

k is an integer from 0 to 5, and

R is an alkyl of 1 to 5 carbon or 1 hydrogen atom.

X constitutes 40-90% (wt/wt) of the impact modifier, and Y constitutes 0-50% (wt/wt), such as 10-40% (wt/wt), preferably 15-35% (wt/wt), most preferably 20-35% (wt/wt) of the impact modifier, and Z constitutes 0.5-20% (wt/wt), preferably 2-10% (wt/wt), most preferably 3-8% (wt/wt) of the impact modifier.

In other mbodiments, X constitutes 70-99.5% (wt/wt) of the impact modifier, preferably 80-95% (wt/wt), most preferably 92-97% (wt/wt) and Y constitutes 0% (wt/wt) of the impact modifier, and Z constitutes 0.5-30% (wt/wt), preferably 5-20% (wt/wt), most preferably 3-8% (wt/wt) of the impact modifier.

Suitable examples of specific impact modifiers that can be used in the resin of the present disclosure include ethylene-ethylene acrylate-glycidyl methacrylate and ethylene-butyl acrylate-glycidyl methacrylate. Commercial available impact modifiers include Paaraloid™ EXM-2314 (an acrylic copolymer from Dow Chemical Company), Lotader® AX8700, Lotader® AX8900, Lotader AX8750®, Lotader® AX8950 and Lotader® AX8840 (manufactured by Arkema) and Elvaloy® PTW (manufactured by DuPont).

Other suitable examples of specific impact modifiers that can be used in the resin of the present disclosure include anhydride modified ethylene acrylates. Commercial available impact modifiers include Lotader® 3210, Lotader® 3410, Lotader® 4210, Lotader® 3430, Lotader® 4402, Lotader® 4503, Lotader® 4613, Lotader® 4700, Lotader® 5500, Lotader® 6200. Lotader® 8200, Lotader® HX8210, Lotader® HX8290, Lotader® LX4110, Lotader® TX8030(manufactured by Arkema), Bynel® 21E533, Bynel® 21E781, Bynel® 21E810 and Bynel® 21E830 (manufactured by DuPont).

In other embodiments, the impact modifier is a modified ethylene vinyl acetate, such as for example Bynel® 1123 or Bynel® 1124 (manufactured by DuPont), an acid modified ethylene acrylate, such as for example Bynel® 2002 or Bynel® 2022 (manufactured by DuPont), a modified ethylene acrylate, such as for example Bynel® 22E757, Bynel® 22E780 or Bynel® 22E804 (manufactured by DuPont), an anhydride modified ethylene vinyl acetate, such as for example Bynel® 30E670, Bynel® 30E671, Bynel® 30E753 or Bynel® 30E783 (manufactured by DuPont), and acid/acrylate modified ethylene vinyl acetate, such as for example Bynel® 3101 or Bynel® 3.126 (manufactured by DuPont), an anhydride modified ethylene vinyl acetate, such as for example Bynel® E418, Bynel® 3810, Bynel® 3859, Bynel® 3860 or Bynel® 3861 (manufactured by DuPont), an anhydride modified ethylene vinyl acetate, such as for example Bynel® 3930 or Bynel® 39E660 (manufactured by DuPont), and anhydride modified high density polyethylene, such as for example Bynel® 4033 or Bynel® 40E529 (manufactured by DuPont), an anhydride modified linear low density polyethylene, such as for example Bynel® 4104, Bynel® 4105, Bynel® 4109, Bynel® 4125, Bynel® 4140, Bynel® 4157, Bynel® 4164, Bynel® 41E556, Bynel® 41E687, Bynel® 41E710, Bynel® 41E754, Bynel® 41E755, Bynel® 41E76.2, Bynel® 41E766, Bynel® 41E850, Bynel® 41E865 or Bynel® 41E871 (manufactured by DuPont) an anhydride modified low density polyethylene, such as for example Bynel® 4206, Bynel® 4208, Bynel® 4288 or Bynel® 42E703 (manufactured by DuPont) or an anhydride modified polypropylene, such as for example Bynel® 50E571, Bynel® 50E662, Bynel® 50E725, Bynel® 50E739, Bynel® 50E803 or Bynel® 50E806 (manufactured by DuPont).

Other suitable impact modifiers include maleic anhydride grafted impact modifiers. Specific examples of such impact modifiers include: chemically is ethylene acrylate copolymers, such as Fusabond® A560 (manufactured by DuPont), an anhydride modified polyethylene, such as Fusabond® E158 (manufactured by DuPont), an anhydride modified polyethylene resin, such as for example Fusabond® E564 or Fusabond® E589 or Fusabond® E226 or Fusabond® E528 (manufactured by DuPont), an anhydride modified high density polyethylene, such as for example Fusabond® E100 or Fusabond® E265 (manufactured by DuPont), au anhydride modified ethylene copolymer, such as for example Fusabond® N525 (manufactured by DuPont). or a chemically modified propylene copolymer, such as for example Fusabond® E353 (manufactured by DuPont).

Yet other suitable impact modifiers include: ethylene-acid copolymer resins, such as ethylene-methacrylic acid (EMAA) based copolymers and ethylene-acrylic acid (EAA) based copolymers. Specific examples of ethylene-methacrylic acid based copolymer impact modifiers include: Nucrel® 403, Nucrel 4071HS, Nucrel® 411HS, Nucrel® 0609HSA, Nucrel® 0903, Nucrel® 0903HC, Nucrel® 908HS, Nucrel® 910, Nucrel® 910HS, Nucrel® 1202HC, Nucrel® 599, Nucrel® 699, Nucrel® 925 and Nucrel® 960 (manufactured by DuPont). Specific examples of ethylene-acrylic acid based copolymers Nucrel® 30707, Nucrel® 30907, Nucrel® 31001, Nucrel® 3990 and Nucrel® AE (manufactured by DuPont). Other specific examples of ethylene of ethylene-acrylic acid (EAA) based copolymers include Escor™ 5000, Escor™ 5020, Escor™ 5050, Escor™ 5080, Escor™ 5100, Escor™ 5200 and Escor™ 6000 (manufactured by ExonMobile Chemical).

Still other suitable impact modifiers; include: ionomers of ethylene acid copolymers. Specific examples of such impact modifiers include Surlyn® 1601, Surlyn® 1601-2, Surlyn® 1601-2LM, Surlyn® 1605. Surlyn® 8150, Surlyn® 8320-Surlyn® 8528, and Surlyn® 8660 (manufactured by DuPont).

In other embodiments, the impact modifier is an alkyl methacrylate-silicone/alkyl tl acrylate graft copolymer. The “alkyl methacrylate” of the graft copolymer may be one selected from the group consisting of methyl methacrylate, ethyl methacrylate, propyl methacrylate, isopropyl methacrylate and butyl methacrylate. The “silicone/alkyl acrylate” in the graft copolymer refers to a polymer obtained by polymerizing a mixture of a silicone monomer and an alkyl acrylate monomer. The silicone monomer may be selected from the group consisting of:

dimethylsiloxane, hexamethylcyclotrisiloxane, octamethylcyclotetrasiloxane, decamethylcyclopentasiloxane, dodecamethylcyclohexasiloxane, trimethyltriphenylcyclotetrasiloxane, tetramethyltetraphenylcyclotetrasiloxane, and octaphenylcyclotetrasiloxane.

The alkyl monomer may be selected from the group consisting of methyl methacrylate, ethyl methacrylate, propyl methacrylate, isopropyl methacrylate, butyl methacrylate and butyl methacrylate. The graft copolymer is in the form of core-shell rubber and has a graft rate of 5 to 90% (wt/wt), a glass transition temperature of the core of −150 to −20 degrees C. and a glass transition temperature of the shell of 20 to 200 degrees C. In one embodiment of the present disclosure, the graft copolymer is methyl. methacrylate-silicone/butyl acrylate graft copolymer. Specific examples include S-2001. S-2100, S-2200 and 5-2501 manufactured by Mitsubishi Rayon Co., Ltd. In Japan.

Other suitable impact .modifiers include the siloxane polymers mentioned in U.S. Pat. No. 4,616,064, which contain siloxane units, and at least one of carbonate, urethane or amide units.

Suitable impact modifiers also include those mentioned in WO 2018/089573 paragraphs [0043]-[0072].

Other suitable impact modifiers include core shell impact modifiers such as those mentioned in U.S. Pat. No. 5,409,967.

The resin comprising recycled ABS polymers may also comprise fillers. Suitable examples of tillers include inorganic particulate materials, nanocomposites or mixtures thereof.

Suitable examples of inorganic particulate material include inorganic oxides, such as glass, MgO, SiO2, TiO2 and Sb2O3; hydroxides, such as Al(OH)3 and Mg(OH)2; salts, such as CaCO3. BaSO4, CaSO4 and phosphates; silicates, such as talc, mica, kaolin, wollastonite. montmorillonite, nanoclay, feldspar and asbestos; metals, such as boron and steel; carbon—graphite, such as carbon fibers, graphite fibers and flakes, carbon nanotubes and carbon black, Suitable examples of inorganic particulate material also include surface treated and/or surface modified SiO2 and TiO2, such as for example alumina surface modified TiO2.

Suitable examples of nanocomposites include clay tilled polymers, such as clay/low density polyethylene (LUPE) nanocomposites, clay/high density polyethylene (HDPE.) nanocomposites, acrylonitrile-butadiene-styrene (ABS)/clay nanocomposites, polyimide (PI)/clay nanocomposites, epoxy/clay nanocomposites, polypropylene (PP)/clay nanocomposites, poly (methyl methacrylate) (PMMA)/clay nanocomposites and polyvinyl chloride (PVC)/clay nanocomposites; alumina filled polymers, such as epoxy/alumina nanocomposites, PMMA/alumina nanocomposites,

PI/alumina nanocomposites, PP/alumina nanocomposites, LDPE/alumina nanocomposites and cross-linked polyethylene (XLPE)/alumina nanocomposites; barium titanate filled polymers, such as HDPE/barium titanate nanocomposites and polyetherimide (PEI)/barium titanate nanocomposites: silica filled polymers, such as PP/silica nanocomposites, epoxy/silica nanocomposites, PVC/silica nanocomposites, PEI/silica nanocomposites, nanocomposites, ABS/silica nanocomposites, and PMMA/silica nanocomposites; and zinc oxide filled. polymers, such as LDPE/zinc oxide nanocomposites, PP/zinc oxide nanocomposites, epoxy/zinc oxide nanocomposites and PMMA/zinc oxide nanocomposites.

The resin comprising recycled ABS polymers may also comprise antioxidants. Suitable examples of antioxidants include phosphites, phenolics, amines and any mixtures thereof.

The resin comprising recycled ABS polymersmay also comprise lubricants. The addition of lubricants may be very important in order to obtain a toy building element with satisfactory surface properties, such as satisfactory surface friction. Suitable examples of lubricants include fatty acids, fatty acid amides and bisamides, fatty acid esters, stearic acids, metallic stearates, inorganic stearates, montan waxes, paraffin waxes, polyethylene waxes, polypropylene waxes, silicone based lubricants and any mixtures thereof.

The resin comprising recycled ABS polymers may also comprise flame retardants. Suitable examples of flame retardants include mineral flame retardants, e.g. magnesium or aluminium hydroxide, organic flame retardants, such as carboxylic acids, and organophosphorus flame retardants.

The resin comprising recycled ABS polymers may also comprise colorants. Suitable examples of colorants include organic pigments, inorganic pigments, solvent dyes, zinc ferrites, carbon black, titanium dioxide, and aluminium oxides.

The resin comprising recycled ABS polymers may also comprise light stabilizers and/or UV absorbers. Suitable examples of light stabilizers/UV absorbers include benzoates, benzophenones, benzotriazoles, hindered amines and triazines.

The resin comprising recycled ABS polymers may also comprise plasticizers. Suitable examples of plasticizers include hydrocarbon processing oil, phosphate esters, such as or example triphenyl phosphate and resorcinol bis(diphenyl phosphate), or oligomeric phosphate, long chain fatty acids and aromatic sulfonamide,

The types and variety of the ABS waste material is important for the uniformity of the ABS polymers in the resin. The more uniform waste material the more uniform resin can be achieved. It is advantageous to use resins with recycled ABS polymers of uniform length and crosslinking and sizes of butadiene spheres. In one embodiment, the recycled ABS polymers are produced from ABS waste material originating from the toy industry.

In a preferred embodiment, the ABS waste material is discarded toy building elements. The main advantage of using discarded toy building elements from a manufacturer's own production plant is that its chemical composition is known and it is also known how to process the material. if the waste material is color-sorted before recycling, then it may be easier to produce recycled toy building elements with uniform color, if the waste material is not color-sorted before recycling, then it may be necessary first to remove the colorants and then add new colorants in order to achieve a final toy building element with a satisfactory color.

Some ABS waste materials contain additives that are hazardous and their presence is therefore not acceptable in the recycled ABS material when used to manufacture toys such as toy building elements. Examples of such hazardous additives include hazardous flame retardants, such as for example halogenated flame retardants, plasticizers, such as for example phthalates and Bisphenol A, hazardous lubricants such as for example fluoropolymers, and inorganic materials, such as cadmium and manganese. Other kinds of additives that may be present in the waste ABS include pigments, such as for example iron oxides, which contribute to continuous degradation of the ABS material during the item's lifetime before the ABS item is thrown out as waste.

In general, the recycled ABS material must fulfil the requirements as specified in for example Regulation (EC) No. 1907/2006 and the Coy Safety Directive (2009/48/EC) or else the ABS waste material is not suitable for use in the manufacturing of toy building elements.

In particular, the amount of substances that are classified as carcinogenic, mutagenic or toxic for reproduction (CMR) of category 1A, 1B or 2 under Regulation (EC) No 1272/2008 must be below the specified limits. Hence, the total content of carcinogenic substances of category 1A and 1B must be 1000 ppm or below, whereas the total content of carcinogenic substances of category 2 must be 10000 ppm or below. The total content of mutagenic substances of category 1A and 1B must be 1000 ppm or below, whereas the total content of mutagenic substances of category 2 must be 10000 ppm or below. The total content of substances, which are toxic for reproduction of category 1A and 1B must be 3000 ppm or below. whereas the total content of substances, which are toxic for reproduction of category 2 must be 30000 ppm or below.

It is also important that the content of metals in the ABS waste material is below the migration limits as specified for example in the Toy Safety Directive (2009/48/EC) or else the waste material is not suitable for use in the manufacturing of toy building elements. In particular, the following migration limits must not be exceeded: aluminum: 70000 rag/kg; antimony: 560 mg/kg; arsenic: 47 mg/kg; barium: 18750 mg/kg; boron: 15000 mg/kg; cadmium 17 mg/kg; chromium(III): 460 mg/kg; chromium(IV): 0,053 mg/kg; cobalt: 130 mg/kg; copper: 7700 mg/kg; lead: 160 mg/kg; manganese: 13000 mg/kg; mercury: 94 mg/kg; nickel: 930 mg/kg; selenium: 460 mg keg; strontium: 56000 mg/kg, tin: 180000 mg/kg: organic tin: 12 mg/kg; and zinc: 46000 mg/kg.

In order to achieve non-hazardous ABS waste material of uniform physical and chemical properties it may be beneficial or even necessary to screen the waste material before recycling. Such screening may include analytical methods for quantifying the ratio of butadiene copolymer to SAN, detection and/or quantifying carcinogenic substances, mutagenic substances, substances, which are toxic for reproduction, antioxidants, heavy metals, halogenated substances, lubricants, flame retardants, colorants and the like. Suitable analytical methods may include Attenuated Total Reflectance Fourier Transform Infrared spectroscopy (ATR-FTIR) to determine the ratio of butadiene copolymer to SAN. Thermogravimetric Analysis (TGA) and/or Differential Scanning calorimetry-Oxidation Induction Time (DSC-OIT) for determining the waste is thermo-oxidative stability. X-Ray Fluorescence spectroscopy (XRF) for determining the amount of heavy metals and/or halogenated substances, and the like. It may also be necessary to screen the ABS waste material for the size of the butadiene spheres and to investigate how the spheres are distributed within the SAN phase. Direct methods for determining the distribution of butadiene spheres in the SAN phase include Scanning Electron Microscopy (SEM) and Transmission Electron Microscopy (TEM), whereas indirect methods include measuring the gloss of the re-molded element.

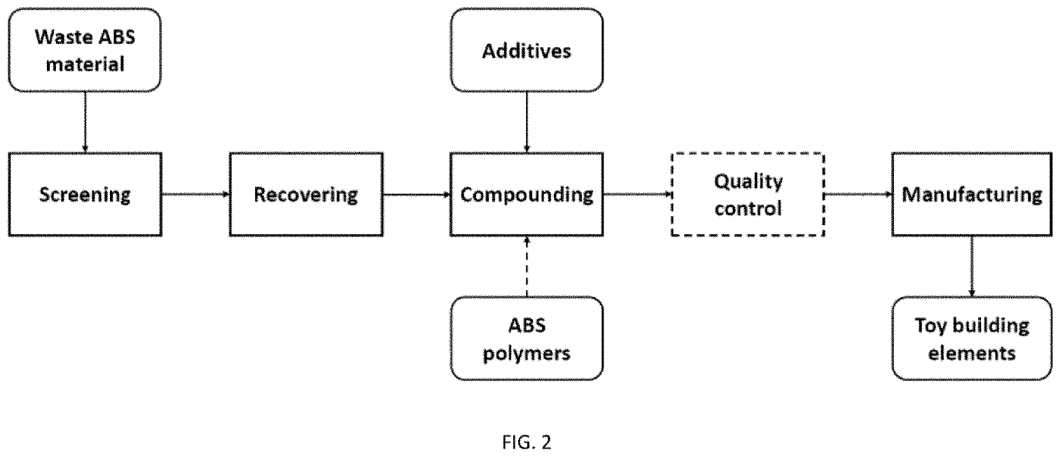

The present disclosure also relates to a method. for the manufacture of a toy building element. The method is shown in FIG. 2. The method comprises the steps of
a) Providing and screening an ABS waste material,
b) recovering recycled ABS polymers from the screened ABS waste material by subjecting the ABS waste material of step a to grinding and/or a solvent dissolution recycling process,
c) obtaining a resin by mixing the recovered ABS polymers of step b with one or more additive(s) and optionally one or more ABS polymers selected from the group consisting of virgin ABS polymers, chemically recycled ABS polymers recovered from pyrolysis and chemically recycled ABS polymers recovered from chemical depolymerization, and
d) manufacturing the toy building element by processing the resin of step c,

Suitable resins to be obtained in step c and processed in stop d include those described above.

The recycled ABS polymers in the resin originate from ABS waste material, which has been subjected to one or more screening processes prior to being. incorporated into the resin so that only material comprising non-hazardous and/or acceptable additives. is incorporated into the resin.

In step a, the ABS waste material is screened for at least one property selected from. the group consisting of:
amount of substances that are classified as carcinogenic, mutagenic or toxic for reproduction (CMR) of category 1A, 1B or 2 under Regulation (EC) No 1272/2008,
migration limit of one or more metals selected from the group consisting of aluminium, antimony, arsenic, barium, boron, cadmium, chromium (111), chromium (IV), cobalt, copper, lead, manganese, mercury, selenium, strontium, tin, organic tin and zinc.
amount of oxides,
amount of phthalates,
amount of flame retardants,
ratio of butadiene copolymer to SAN,
size and size distribution of butadiene spheres, and
level of crosslinking raf the butadiene spheres.

It is very important that the amount of substances that are classified as carcinogenic, mutagenic or toxic for reproduction (CMR) of category 1A, 1B or 2 under Regulation (EC) No 1272/2008 is below the specified limits or else the waste material is not suitable for use for manufacturing toys. Hence, the total content of carcinogenic substances of category 1A and 1B must be 1000 ppm or below, whereas the total content of carcinogenic substances of category 2 must be 10000 ppm or below. The total content of mutagenic substances of category 1A and 1B must be 1000 ppm or below, whereas the total content of mutagenic substances of category 2 must be 10000 ppm or below. The total content of substances, which are toxic for reproduction of category 1A and 1B must be 3000 ppm or below, whereas the total content of substances, which are toxic for reproduction of category 2 must be 30000 ppm or below.

It is also important that the content of metals in the ABS waste material is below the migration limits as specified for example in the Toy Safety Directive (2009/48 EC) or else the waste material is not suitable for use in the manufacturing of toy building elements. In particular, the following migration limits must not be exceeded: aluminum: 70000 mg/kg; antimony: 560 mg/kg, arsenic: 47 mg/kg; barium: 18750 mg/kg; boron: 15000 mg/kg; cadmium 17 mg/kg; chromium(M): 460 mg/kg; chromium(iV): 0.053 mg/kg; cobalt: 130 mg/kg; copper: 7700 mg/kg; lead: 160 mg/kg; manganese: 15000 mg/kg; mercury: 94 mg/kg; nickel: 930 mg/kg; selenium: 460 mg/kg; strontium: 56000 mg/kg; tin: 180000 mg/kg; organic tin: 12 mg/kg; and zinc: 46000 mg/kg.

The amount of iron-oxides must also be kept at kept at very low levels in order to avoid chemical degradation over time of the ABS polymers and in particular avoid the formation of ABS monomers, which result in poor mechanical properties of the manufactured toy building element and hence become a product safety issue. Also, the amount of toxic compounds such as phthalates and flame retardants must be avoided if the ABS waste material is to be used for manufacture of toys.

It is also important that the waste ABS material is screened for ratio of butadiene copolymer to SAN, and the size of butadiene spheres. The butadiene content in the ABS material is preferably in the range of 15-22 wt % based on total ABS polymer. The size of the butadiene spheres is preferably less than or equal to 0.5 micrometers in order to obtain a glossy surface of the manufactured toy building element.

In some cases the waste ABS material may be very inhomogeneous and in such cases it may be necessary to sort the waste ABS material prior to screening for the above mentioned properties.

In step b, the screened ABS waste material is subjected to grinding and/or a solvent dissolution recycling process in order to recover the recycled ABS polymers.

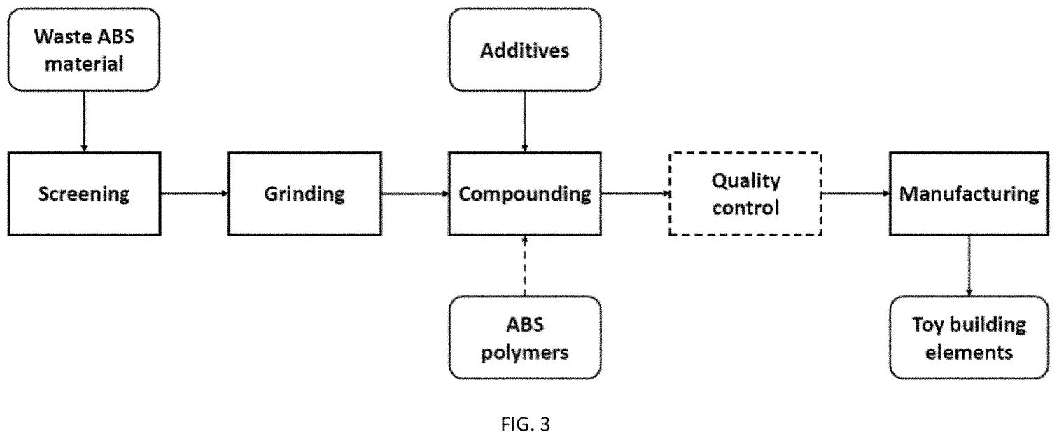

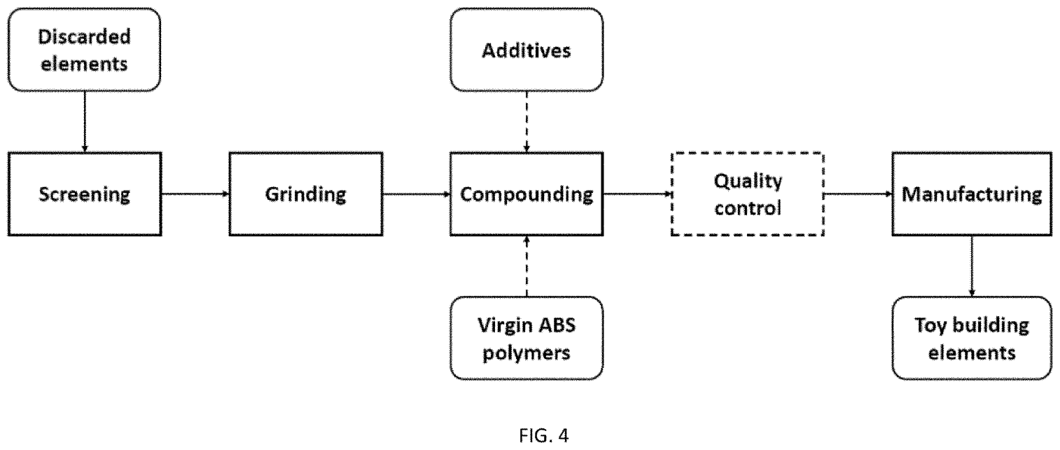

A method of manufacturing toy building elements by processing a resin comprising mechanically recycled ABS polymers are shown in FIGS. 3 and 4. In this method the screened ABS waste material is subjected. to grinding, in the grinding step, the recycled. material is crushed/cut into small pieces of material. The step is important in order to obtain a homogenous mixture of material, which is easily mixed with additives and optionally other ABS polymers and which is also easily melted during the manufacture of the toy building element, i,e, during the injection molding, the extrusion or the additive manufacturing process.

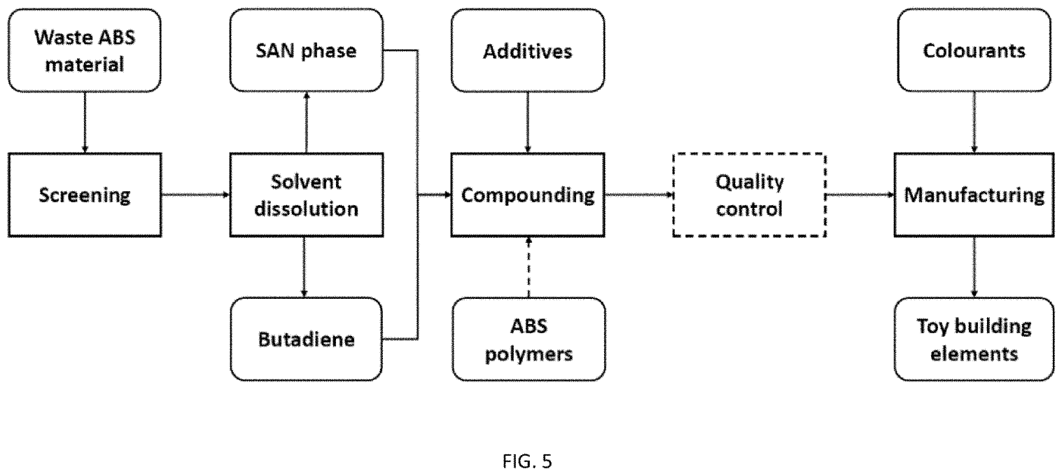

A method of manufacturing toy building elements by processing a resin comprising chemically recycled ABS polymers are shown in FIGS. 5, 6 and 7. In this method the screened ABS waste material is subjected to a solvent dissolution recycling process. Typically, the waste ABS material is subjected to grinding prior to dissolution in order to facilitate dissolution of the waste material, but the grinding step is not mandatory.

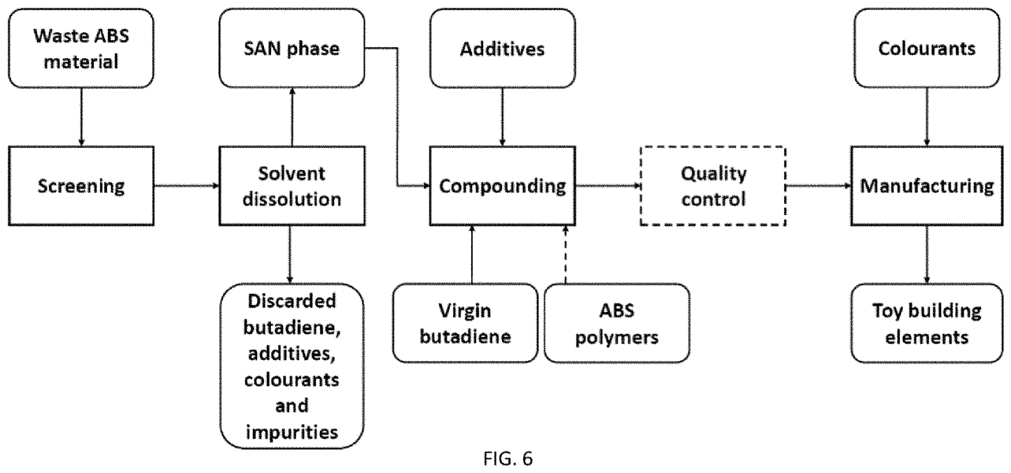

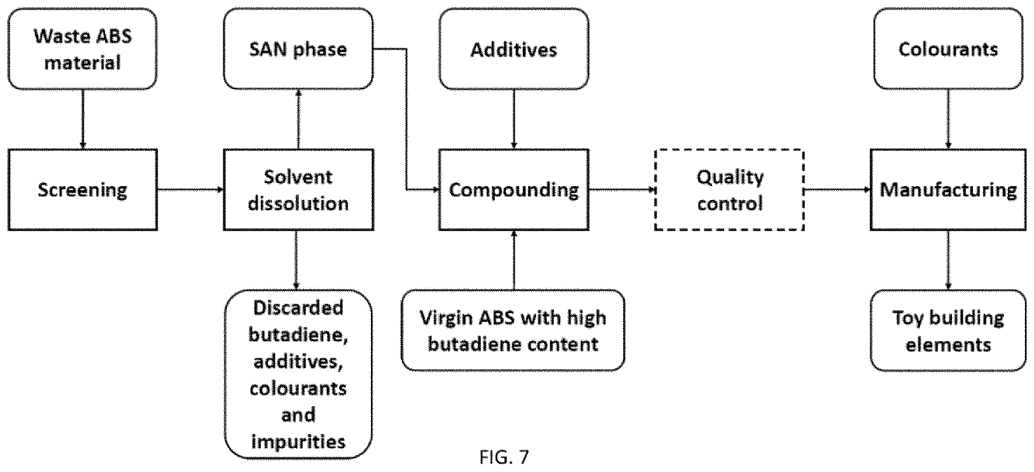

During the dissolution step, the ABS waste material is dissolved and the ABS polymers may be divided into two phases: one phase contains the poly(styrene-co-acrylonitrile) chains, also referred to as the SAN phase, and the other phase contains the butadiene copolymers, also referred to as the butadiene spheres. In some embodiments, both the SAN phase and the butadiene spheres are recycled (FIG. 5), whereas in other embodiments only the SAN phase is recycled (FIGS. 6 and 7).

In step c, the recycled ABS polymers are mixed with other compounds and formed into a resin. Preferably, the mixing step is a compounding step. During mixing one or more additives are mixed with the recycled ABS polymers, and optionally virgin and/or virgin-like. ABS polymers may also be mixed into the resin. Suitable additives include impact modifiers, fillers, antioxidants, lubricants, flame retardants, colorants, light stabilizers/UV absorbers and/or plasticizers. The virgin and/or virgin-like ABS polymers may be bio-based ABS polymers and/or hybrid bio-based polymers. Moreover, the virgin-like ABS polymers may be ABS polymers recovered from a chemical pyrolysis recycling process or a chemical depolymerization recycling process.

In a particular preferred embodiment, the waste ABS mate-rial is discarded toy building elements as shown in FIG. 4. In these embodiments, the addition of additives may not be necessary because the discarded toy building elements may already possess the mechanical properties necessary in order to manufacture toy building elements with the required properties.

In step d, the toy building element is manufactured by processing the resin obtained in step c. In some embodiments, the toy building element is manufactured by injection molding. In such embodiments, the mixing of the recycled ABS polymers with additives and/or colorants and optionally further virgin or virgin-like ABS polymers may take place prior to feeding the resin to the injection molding machine. In some embodiments, the mixing may be performed as a dry mixing step or a compounding step. In other embodiments, the mixing may be performed by using a compounding step in an extrusion machine prior to the injection molding step. In yet other embodiments, the additives may be mixed into a masterbatch, which is then mixed with the rest of the ABS resin during feeding of the injection molding machine. Alternatively, the mixing may take place during feeding the resin to the injection molding machine.

In yet other embodiments, the toy building element is manufactured by extrusion, optionally followed by molding using thermoforming or similar technology.

In some embodiments, the toy building element is manufactured by additive. manufacturing. Suitable examples of additive manufacturing techniques are those in which the toy building element is built by photopolymerization additive manufacturing or thermoplastic additive manufacturing, such as liquid-based additive manufacturing, toner-based additive manufacturing, powder-based additive manufacturing or granulate-based additive manufacturing.

Preferably, the method also contains a step in which the resin obtained in step c is subjected to quality control before the resin is manufactured. into toy building elements in step d. The quality control is primarily to make sure that important mechanical properties are as necessary in order to obtain a final toy building element with required properties. Examples of mechanical properties that are typically measured includes one or more of impact strength, surface friction, surface gloss and color.

### EXAMPLES

In the examples below it is described how ABS is recirculated by regrinding molded elements and runners and then using this regrind material to produce new elements by injection molding. In Example 1, all of the ABS material is recycled and in Example 2, recycled ABS is mixed with virgin ABS before a new element is injection molded.

The impact strength of the injection molded elements is tested by the “Charpy v-notch test”.

Charpy v-notch test

Molded plastic rods with dimensions of 6.0×4.0×50.0 mm³, B×W×H, and in the relevant material to be tested were cut according to ISO 179-1/1 eA with a notch cutter (ZNO, Zwick, Germany) with a notch tip diameter of 0.5 mm. The notched specimens were placed with v-notch opposite pendulum and tested in a pendulum impact machine (HOT, Zwick, Genitally) according to the principles described m ISO 179-1:2010.

### Example 1

### Properties of ABS from Mechanical Recycling—Complete Recycling of ABS

Virgin ABS Terluran® GP35 (supplied by INEOS Styrolution) was dried at 80 degrees ,C. for 4 hrs. ABS was processed via injection molding (Arburg. Allrounder 470 E 1000-400, 30 mm screw, Germany) into impact bars and runners. 10 impact bars were tested in the Charpy v-notch test, and the results are recorded in the table below as regrind cycle 0.

Remaining runners and impact bars were ground back to pellets in a plastic grinding machine. The ground ABS pellets were again processed into impact bars and runners, 10 impact bars were used in the Charpy v-notch test, and the results recorded as regrind cycle 1. In a similar manner the remaining impact bars and runners were ground and reprocessed in up to 10 regrind cycles.

The injection molding parameters were as follows:

Melt temperature: 240 degrees C.

Mold temperature: 30 degrees C.

The results are shown e table below.

| | Relative Charpy |
|---|---|
| Regrind cycle number | v-notch value |
| 0 | 100 |
| 1 | 100 |
| 5 | 95 |
| 10 | 88 |

The results show that one regrind cycle does not appear to affect Charpy v-notch at all, whereas 5 regrind cycles cause the relative Charpy v-notch value to decrease from 100 to 95. Such decrease would probably still be acceptable in cases where a toy building element is produced. A further decrease in relative Charpy v-notch to 88 is seen after 10 regrind cycles. This indicates that toy building elements made of ABS, which has been recycled 10 times would most likely possess unacceptable mechanical properties due to insufficient impact strength. Hence, new or additional impact modifiers need to be mixed into the recycled material in order to improve the impact strength to an acceptable level.

### Example 2

### Properties of ABS from Mechanical recycling—Partly Recycling of ABS

Two molds producing different sized elements were used to test the. effects of applying different amounts of mechanically recycled ABS in the molding process. ln this study, the amount of mechanically recycled ABS was represented by the percentage of mechanically regrind runner systems that were introduced back into the molding process of ABS. The two molds applied in the test were constructed to run with 42% and 90% regrind of runners during the molding process. These two molds were used. to investigate whether supplementing regrind ABS with different levels of virgin ABS could help maintain good overall impact properties of the molded element. The two molds described above were used to generate input material for 3 additional molds running with 37%, 51% and 85% regrind, respectively.

Virgin ABS Terluran® GP35 (supplied by INEOS Styrolution) was dried at 80 degrees C. for 4 hrs. ABS was processed via injection molding (Arburg, Allrounder 470 F 1000-400, 30 mm screw, Germany) into LEGO® elements using mold no. 1 and 2. The molds were fed with regrind and virgin ABS according to the table below. Due to the levels of regrind material introduced in the process, the molds need to produce a number of shots before the overall process is stabilized, i.e. before a steady state situation is reached. The number of shots ensuring a stable process is indicated in the table below.

| Mold | Regrind | | Number of shots for |
|---|---|---|---|
| no. | ABS, % | Input material | process stabilization |
| 1 | 42 | Virgin ABS | 5589 |
| 2 | 90 | Virgin ABS | 2789 |
| 3 | 37 | From mold 1 or mold 2 | 2476 |
| 4 | 51 | From mold 1 or mold 2 | 5575 |
| 5 | 85 | From mold 1 or mold 2 | 13206 |

Once a stable process was reached samples of blended material that was ready to be molded were collected, and these samples were processed into impact bars via injection molding. The molded impact bars were used for Charpy v-notch analysis, and the results are shown in the table below.

Stable processing material generated for mold 1 and 2 was furthermore used as input material for processing in molds 3, 4 and 5, Once a stable process was reached material samples were collected and used to produce impact bars that were tested in Charpy v-notch analysis. The results are shown in the table below.

| | Relative Charpy |
|---|---|
| Material used to produce impact bars | v-notch value |
| virgin GP-35 | 100 |
| mold 1 (after stable process) | 108 |
| mold 2 (after stable process) | 100 |
| mold 1 + mold 3 (after stable process) | 112 |
| mold 1 + mold 4 (after stable process) | 109 |
| mold 1 + mold 5 (after stable process) | 85 |
| mold 2 + mold 3 (after stable process) | 94 |
| mold 2 + mold 4 (after stable process) | 86 |
| mold 2 + mold 5 (after stable process) | 69 |

The results show that the addition of some amount of mechanically recycled ABS to virgin ABS in the molding process surprisingly provides an increase in the relative Charpy v-notch value. In particular, mold 1 running with 42% regrind. shows an increase in relative Charpy v-notch value to 108%. And when the steady state material from mold 1 is used as input material for mold 3 the relative Charpy v-notch value further increases to 112% as compared to the use of virgin material. The inventors of the present disclosure have observed such increases in relative Charpy v-notch value. several times and it may indicate that an improved dispersion of polybutadiene spheres is obtained when recycled ABS material is mixed with virgin ABS.

The results also show that as the number of recirculation cycles of the ABS increases the relative Charpy v-notch value decreases resulting in molded elements with decreased impact strength. The exact Charpy v-notch value that could be acceptable when using the recycled. ABS for producing toy building elements will depend on the type of element, which is produced; for example, a traditional LEGO® brick requires higher impact strength than a LEGO® DUPLO® brick. But eventually, independently on the type of element, the recycled ABS material can no longer produce toy building bricks with satisfactory mechanical properties, and new or additonal impact modifiers or virgin ABS need to be mixed with the recycled ABS in order to produce toy building elements with acceptable impact strength.

The above experimental results show, that ABS may be mechanically recycled to some extent but, eventually, upgrading of the mechanical properties are required in order to produce toy building elements with acceptable .mechanical properties, such as acceptable impact strength.

What is Claimed is:

1. A toy building element made of recycled Acrylonitrile Butadiene Styrene (“ABS”) material and manufactured by processing of a resin comprising, mechanically recycled ABS polymers and/or chemically recycled ABS polymers recovered from a solvent dissolution recycling process.

2. The toy building element according to claim 1, wherein the resin further comprises virgin ABS polymers or chemically recycled Acrylonitrile Butadiene Styrene ABS polymers recovered from a pyrolysis recycling process or chemically recycled ABS polymers recovered from a chemical depolymerisation recycling process or any combination thereof.

3. (canceled)

4. The toy building element according claim 1, wherein the size of butadiene spheres in the recycled ABS polymers is less than or equal to 0.5 micrometers.

5. The toy building element according to claim 2, wherein the weight ratio between the mechanically recycled ABS polymers and virgin ABS polymers is in the range of 100:0 to 5:95.

6. The toy building element according to claim 1, wherein at least part of the ABS polymers is bio-based ABS polymers and/or hybrid bio-based ABS polymers and/or ABS polymers produced using carbon capture techniques.

7. The toy building element according to claim 1, wherein the total amount of ABS polymers in the resin. is at least 50 wt % relative to the total weight of the resin.

8. (canceled)

9. (canceled)

10. (canceled)

11. The toy building element according to claim 1, wherein the toy building element is produced by injection molding using a mold running with 20-95 wt %, such as for example 30-90 wt %, recycled material after steady state.

12. A method for the manufacture of a toy building element, comprising the steps of:
a) providing and screening an Acrylonitrile Butadiene Styrene (“ABS”) waste material,
b) recovering recycled ABS polymers from the screened ABS waste material by subjecting the ABS waste material of step a to grinding andior a solvent dissolution recycling process,
c) obtaining a resin by mixing the recovered ABS polymers of step b with one or more additive(s), and
d) manufacturing the toy building element by processing the resin of step c.

13. The method according to claim 12, further comprising the step of:
screening the ABS waste material for at least one property selected from. the group consisting of:
amount of substances that are classified as carcinogenic, mutagenic or toxic for reproduction (CMR) of category 1A, 1 B or 2 under Regulation (EC) No 1272/2008.
migration limit of one or more metals selected from the group consisting of aluminium, antimony, arsenic, barium boron, cadmium, chromium (III), chromium (IV), cobalt, copper, lead, manganese, mercury, selenium, strontium, tin, organic tin and zinc,
amount of oxides,
amount of phthalates,
amount of flame retardants,
ratio of butadiene copolymer to SAN,
size and size distribution of butadiene spheres, and
level of crosslinking of the butadiene spheres.

14. The method according to claim 12, wherein the screened ABS waste material is subjected to grinding in step h and the recovered ABS polymers are recycled as mechanically recycled ABS polymers.

15. The method according to claim 12, wherein the screened ABS waste mat trial is subjected to a solvent dissolution recycling process in step b, thereby obtaining a SAN phase containing polystyrene-co-acrylonitrile) chains and a butadiene phase containing copolymers of butadiene and wherein at least the SAN phase is recycled as the chemically recycled ABS polymers.

16. The method according to claim 12, further comprising the step of:
compounding the recovered ABS polymers with one or more additive(s) selected from the group consisting of impact modifiers, fillers, antioxidants, lubricants, flame retardants, colorants, light stabilizers/UV absorbers and plasticizers.

17. The method according to claim 12, wherein processing the resin of step c comprises: injection molding, extrusion, or additive manufacturing, or a combination of injection molding, and additive manufacturing of the resin obtained in step c.

18. The method according to claim 12, further comprising the step of:
subjecting the resin obtained in step c to quality control before the resin is manufactured into toy building elements in step d.

19. The method according to claim 18, wherein the quality control comprises the step of: measuring one or more mechanical properties of the resin, wherein said mechanical properties are selected from the group consisting of:
impact strength,
surface friction,
surface gloss, and
color.

20. The method according to claim 12, wherein the ABS waste material is discarded toy building elements.

21. A toy building element made of mechanically recycled ABS material in accordance with the process of claim 12.

22. (canceled)

23. A toy building element made of recycled Acrylonitrile Butadiene Styrene (“ABS”) material, wherein the ABS material does not include a carcinogenic, a mutagenic or a toxic for reproduction (CMR) substance identified in category 1A, 1B or 2 under Regulation (EC) No 1272/2008.

24. The toy building element according to claim 1, wherein the recycled ABS polymers are produced from ABS waste material originating from the toy industry.

25. The toy building element according to claim 24, wherein the ABS waste material i.s discarded toy building elements.

26. The method according to claim 12, wherein the resin in step c is obtained by further mixing the recovered ABS polymers and additives with one or more ABS polymers selected from the group consisting of: virgin ABS polymers, chemically recycled ABS polymers recovered from pyrolysis, and chemically recycled ABS polymers recovered from chemical &polymerisation.
